(19) United States
(12) Patent Application Publication
(10) Pub. No.: US 2024/0385590 A1
(43) Pub. Date: Nov. 21, 2024

(54) SYSTEMS, APPARATUSES, METHODS, AND COMPUTER PROGRAM PRODUCTS FOR CONTROLLING DATA PROCESSING PIPELINES USING PID CONTROL

(71) Applicant: HONEYWELL INTERNATIONAL INC., Charlotte, NC (US)

(72) Inventor: Bhabesh Chandra ACHARYA, Bangalore (IN)

(21) Appl. No.: 18/320,578

(22) Filed: May 19, 2023

(51) Int. Cl. G05B 19/4155

(52) U.S. Cl. CPC G05B 19/4155; G05B 2219/42033

(57) ABSTRACT

Systems, apparatuses, methods, and computer program products are provided herein. For example, a method included herein includes receiving monitoring data representing operations of a data publisher, a data processing unit, and a database. In some embodiments, the method may include determining a first data processing error associated with the data publisher and the data processing unit based at least in part on the monitoring data. In some embodiments, the method may include determining a second data processing error associated with the data processing unit and the database. In some embodiments, the method may include causing a first controller to control the data publisher or the data processing unit. In some embodiments, the method may include causing a second controller to control the data processing unit or the database based at least in part on the second data processing error.

### TECHNOLOGICAL FIELD

Embodiments of the present disclosure relate generally to systems, apparatuses, methods, and computer program products for controlling data processing pipelines, such as data publishers, data processing units, and/or databases, using PID control.

### BACKGROUND

Applicant has identified many technical challenges and difficulties associated with systems, apparatuses, methods, and computer program products for controlling data processing pipelines, such as data publishers, data processing units, and/or databases, using PID control. Through applied effort, ingenuity, and innovation, Applicant has solved problems related to systems, apparatuses, methods, and computer program products for controlling data processing pipelines, such as data publishers, data processing units, and/or databases, using PID control by developing solutions embodied in the present disclosure, which are described in detail below.

### BRIEF SUMMARY

Various embodiments described herein relate to systems, apparatuses, methods, and computer program products for controlling data processing pipelines, such as data publishers, data processing units, and/or databases, using PID control.

In accordance with one aspect of the disclosure, a computer-implemented method is provided. In some embodiments, the computer-implemented method may include receiving monitoring data representing operations of a data publisher, a data processing unit, and a database. In some embodiments, the computer-implemented method may include determining a first data processing error associated with the data publisher and the data processing unit based at least in part on the monitoring data. In some embodiments, the computer-implemented method may include determining a second data processing error associated with the data processing unit and the database based at least in part on the monitoring data. In some embodiments, the computer-implemented method may include causing a first controller to control the data publisher or the data processing unit based at least in part on the first data processing error. In some embodiments, the computer-implemented method may include causing a second controller to control the data processing unit or the database based at least in part on the second data processing error.

In some embodiments, the first controller is a first proportional-integral-derivative (PID) controller and the second controller is a second PID controller.

In some embodiments, the monitoring data comprises one or more of a publisher data flow rate, a data processing flow rate, a computing resource consumption amount, and a data storage rate.

In some embodiments, the data publisher is configured to transmit publisher data to the data processing unit at the publisher data flow rate.

In some embodiments, the data processing unit is configured to generate data processing data based at least in part on the publisher data.

In some embodiments, the data processing unit is configured to transmit the data processing data to the database at the data processing flow rate.

In some embodiments, causing the first controller to control the data publisher comprises causing the first controller to instruct the data publisher to increase the publisher data flow rate or decrease the publisher data flow rate.

In some embodiments, decreasing the publisher data flow rate comprises the data publisher storing at least a portion of the publisher data in a data publisher cache.

In some embodiments, causing the first controller to control the data processing unit comprises causing the first controller to instruct the data processing unit to increase the computing resource consumption amount or decrease the computing resource consumption amount.

In some embodiments, causing the second controller to control the data processing unit comprises causing the second controller to instruct the data processing unit to increase the data processing flow rate or decrease the data processing flow rate.

In some embodiments, decreasing the data processing flow rate comprises the data processing unit storing at least a portion of the data processing data in a data processing unit cache.

In some embodiments, causing the second controller to control the database comprises causing the second controller to instruct the database to increase the data storage rate or decrease the data storage rate.

In accordance with another aspect of the disclosure, an apparatus is provided. In some embodiments, the apparatus may include at least one processor and at least one non-transitory memory including computer-coded instructions thereon. In some embodiments, the apparatus may be caused to receive monitoring data representing operations of a data publisher, a data processing unit, and a database. In some embodiments, the apparatus may be caused to determine a first data processing error associated with the data publisher and the data processing unit based at least in part on the monitoring data. In some embodiments, the apparatus may be caused to determine a second data processing error associated with the data processing unit and the database based at least in part on the monitoring data. In some embodiments, the apparatus may be caused to cause a first controller to control the data publisher or the data processing unit based at least in part on the first data processing error. In some embodiments, the apparatus may be caused to cause a second controller to control the data processing unit or the database based at least in part on the second data processing error.

In some embodiments, the first controller is a first proportional-integral-derivative (PID) controller and the second controller is a second PID controller.

In some embodiments, the monitoring data comprises one or more of a publisher data flow rate, a data processing flow rate, a computing resource consumption amount, and a data storage rate.

In some embodiments, the data publisher is configured to transmit publisher data to the data processing unit at the publisher data flow rate.

In some embodiments, the data processing unit is configured to generate data processing data based at least in part on the publisher data.

In some embodiments, the data processing unit is configured to transmit the data processing data to the database at the data processing flow rate.

In some embodiments, causing the first controller to control the data publisher comprises causing the first controller to instruct the data publisher to increase the publisher data flow rate or decrease the publisher data flow rate.

In some embodiments, decreasing the publisher data flow rate comprises the data publisher storing at least a portion of the publisher data in a data publisher cache.

In some embodiments, causing the first controller to control the data processing unit comprises causing the first controller to instruct the data processing unit to increase the computing resource consumption amount or decrease the computing resource consumption amount.

In some embodiments, causing the second controller to control the data processing unit comprises causing the second controller to instruct the data processing unit to increase the data processing flow rate or decrease the data processing flow rate.

In some embodiments, decreasing the data processing flow rate comprises the data processing unit storing at least a portion of the data processing data in a data processing unit cache.

In some embodiments, causing the second controller to control the database comprises causing the second controller to instruct the database to increase the data storage rate or decrease the data storage rate.

In accordance with another aspect of the disclosure, a computer program product is provided. In some embodiments, the computer program product includes at least one non-transitory computer-readable storage medium having computer program code stored thereon. In some embodiments, the computer program product may be configured for receiving monitoring data representing operations of a data publisher, a data processing unit, and a database. In some embodiments, the computer program product may be configured for determining a first data processing error associated with the data publisher and the data processing unit based at least in part on the monitoring data. In some embodiments, the computer program product may be configured for determining a second data processing error associated with the data processing unit and the database based at least in part on the monitoring data. In some embodiments, the computer program product may be configured for causing a first controller to control the data publisher or the data processing unit based at least in part on the first data processing error. In some embodiments, the computer program product may be configured for causing a second controller to control the data processing unit or the database based at least in part on the second data processing error.

In some embodiments, the first controller is a first proportional-integral-derivative (PID) controller and the second controller is a second PID controller.

In some embodiments, the monitoring data comprises one or more of a publisher data flow rate, a data processing flow rate, a computing resource consumption amount, and a data storage rate.

In some embodiments, the data publisher is configured to transmit publisher data to the data processing unit at the publisher data flow rate.

In some embodiments, the data processing unit is configured to generate data processing data based at least in part on the publisher data.

In some embodiments, the data processing unit is configured to transmit the data processing data to the database at the data processing flow rate.

In some embodiments, causing the first controller to control the data publisher comprises causing the first controller to instruct the data publisher to increase the publisher data flow rate or decrease the publisher data flow rate.

In some embodiments, decreasing the publisher data flow rate comprises the data publisher storing at least a portion of the publisher data in a data publisher cache.

In some embodiments, causing the first controller to control the data processing unit comprises causing the first controller to instruct the data processing unit to increase the computing resource consumption amount or decrease the computing resource consumption amount.

In some embodiments, causing the second controller to control the data processing unit comprises causing the second controller to instruct the data processing unit to increase the data processing flow rate or decrease the data processing flow rate.

In some embodiments, decreasing the data processing flow rate comprises the data processing unit storing at least a portion of the data processing data in a data processing unit cache.

In some embodiments, causing the second controller to control the database comprises causing the second controller to instruct the database to increase the data storage rate or decrease the data storage rate.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Reference will now be made to the accompanying drawings. The components illustrated in the figures may or may not be present in certain embodiments described herein. Some embodiments may include fewer (or more) components than those shown in the figures in accordance with an example embodiment of the present disclosure.

FIG. 1 illustrates an exemplary block diagram of an environment in which embodiments of the present disclosure may operate;

FIG. 2 illustrates an exemplary block diagram of an example optimized control system in accordance with an example embodiment of the present disclosure;

FIG. 3 illustrates an example user interface in accordance with one or more embodiments of the present disclosure; and

FIG. 4 illustrates a flowchart of an example computer-implemented method in accordance with one or more embodiments of the present disclosure.

### DETAILED DESCRIPTION

Some embodiments of the present disclosure will now be described more fully herein with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

The use of the term “circuitry” as used herein with respect to components of a system, or an apparatus should be understood to include particular hardware configured to perform the functions associated with the particular circuitry as described herein. The term “circuitry” should be understood broadly to include hardware and, in some embodiments, software for configuring the hardware. For example, in some embodiments, “circuitry” may include processing circuitry, communication circuitry, input/output circuitry, and the like. In some embodiments, other elements may provide or supplement the functionality of particular circuitry. Alternatively or additionally, in some embodiments, other elements of a system and/or apparatus described herein may provide or supplement the functionality of another particular set of circuitry. For example, a processor may provide processing functionality to any of the sets of circuitry, a memory may provide storage functionality to any of the sets of circuitry, communications circuitry may provide network interface functionality to any of the sets of circuitry, and/or the like.

### Overview

Example embodiments disclosed herein address technical problems associated with systems, apparatuses, methods, and computer program products for controlling data processing pipelines, such as data publishers, data processing units, and/or databases, using PID control. As would be understood by one skilled in the field to which this disclosure pertains, there are numerous example scenarios in which a user may use systems, apparatuses, methods, and computer program products for controlling data processing pipelines, such as data publishers, data processing units, and/or databases, using PID control.

In many computing applications, it is necessary to control the flow and processing of data such that the computing application is able to consistently and accurately move data through the computing application and process the data (e.g., it is necessary to control data processing pipelines). For example, it may be necessary for a computing application to be able to consistently and accurately move and processes real-time data (e.g., data that is continuously received via a real-time data stream) and/or move and processes batch data (e.g., a large batch of data that is received all at once).

Example solutions for controlling the flow and processing of data in a computing application include, for example, scaling various components of the computing application (e.g., adding another computing node to a processing unit in the computing application) such that each component of the computing application is able to consistently and accurately control the flow and processing of the data. For example, a computing application may include a processing unit that continuously processes real-time data received by the system. If the computing application receives a batch of other data and/or the rate at which the system receives real-time data increases, the computing application may scale up the processing unit such that the processing unit may be able to process the increase in real-time data and/or the batch data. However, such an example solution has several drawbacks. For example, it may not be possible to scale up a processing unit sufficiently such that the processing unit can process both the increase in real-time data and/or the batch data, which results in the computing application being unable to consistently and accurately move and/or process the data. As another example, the computing application may not know whether the computing application may receive another batch of data and/or whether the rate at which the system receives the real-time data may decrease, so the computing application may be reluctant to scale down the processing unit, which increases costs and wastes computing resources. Accordingly, systems, apparatuses, methods, and computer program products are needed that can control a computing application and/or components associated with the computing application such that the computing application can move and process data in a consistent, accurate, and efficient manner.

Thus, to address these and/or other issues related to systems, apparatuses, methods, and computer program products related to controlling data processing pipelines, such as data publishers, data processing units, and/or databases, using PID control, example systems, apparatuses, methods, and computer program product are disclosed herein. For example, an embodiment in this disclosure, described in greater detail below, includes a computer-implemented method that includes receiving monitoring data representing operations of a data publisher, a data processing unit, and a database. In some embodiments, the computer-implemented method may include determining a first data processing error associated with the data publisher and the data processing unit based at least in part on the monitoring data. In some embodiments, the computer-implemented method may include determining a second data processing error associated with the data processing unit and the database based at least in part on the monitoring data. In some embodiments, the computer-implemented method may include causing a first controller to control the data publisher or the data processing unit based at least in part on the first data processing error. In some embodiments, the first controller may be a PID controller. In some embodiments, the computer-implemented method may include causing a second controller to control the data processing unit or the database based at least in part on the second data processing error. In some embodiments, the second controller may be a second PID controller. Accordingly, the systems, apparatuses, methods, and computer program products enable for consistent, accurate, and efficient movement and processing of data in a computing application through the use of PID control.

### Example Apparatuses and Systems

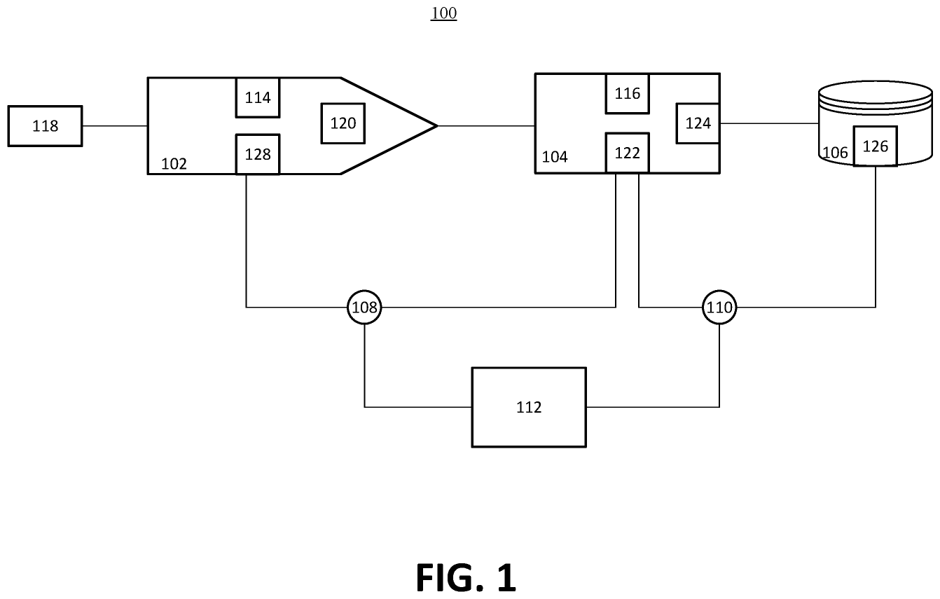

FIG. 1 illustrates an exemplary block diagram of an environment 100 in which embodiments of the present disclosure may operate. It will be appreciated that the environment 100 as well as the illustrations in other figures are each provided as an example of an embodiment(s) and should not be construed to narrow the scope or spirit of the disclosure in any way. In this regard, the scope of the disclosure encompasses many potential embodiments in addition to those illustrated and described herein. As such, while FIG. 1 illustrates one example of a configuration of an exemplary block diagram of an environment 100 in which embodiments of the present disclosure may operate, numerous other configurations may also be used to implement embodiments of the present disclosure.

The environment 100 may include an optimized control system 112. The optimized control system 112 may comprise one or more servers, a server cluster, one or more network nodes, a cloud computing infrastructure, one or more desktop computers, one or more laptop computers, one or more mobile computing devices, one or more kiosks, one or more input terminals, some combination thereof, or the like. The environment 100 may include a first controller 108 and a second controller 110. The first controller 108 may be a first proportional-integral-derivative (PID) controller and the second controller 110 may be a second PID controller.

The environment 100 may include a data publisher 102. The data publisher 102 may be embodied by any computing device, such as by way of non-limiting example, one or more servers, a server cluster, one or more network nodes, a cloud computing infrastructure, one or more desktop computers, one or more laptop computers, one or more mobile computing devices, one or more kiosks, one or more input terminals, some combination thereof, or the like. In some embodiments, the data publisher 102 may be configured to receive and/or transmit data.

In some embodiments, the data publisher 102 may include a data publisher cache 114. The data publisher cache 114 may be configured to receive, store, and/or transmit data associated with the data publisher 102. For example, the data publisher cache 114 may comprise a temporary storage associated with the data publisher 102. In some embodiments, the data publisher 102 may include a data publisher streaming queue 120. The data publisher streaming queue 120 may be configured to receive, store, and/or transmit data associated with the data publisher 102. For example, the data publisher streaming queue 120 may be configured to transmit data to another component in the environment 100 (e.g., stream data). In some embodiments, the data publisher 102 may include a data publisher command queue 128. The data publisher command queue 128 may be configured to receive and/or transmit data. For example, the data publisher command queue 128 may be configured to receive data indicating a command associated with the optimized control system 112. Although the data publisher cache 114, the data publisher streaming queue 120, and the data publisher command queue 128 are depicted as components of the data publisher 102 in FIG. 1, it would be understood by one skilled in the field to which this disclosure pertains that the data publisher 102, data publisher cache 114, the data publisher streaming queue 120, and the data publisher command queue 128 may be separate components.

The environment 100 may include a computing device 118. The computing device 118 may be embodied by any computing device, such as by way of non-limiting example, one or more servers, a server cluster, one or more network nodes, a cloud computing infrastructure, one or more desktop computers, one or more laptop computers, one or more mobile computing devices, one or more kiosks, one or more input terminals, some combination thereof, or the like. In some embodiments, the computing device 118 may be configured to receive, generate, and/or transmit data.

The environment 100 may include a data processing unit 104. The data processing unit 104 may be embodied by any computing device, such as by way of non-limiting example, one or more servers, a server cluster, one or more network nodes, a cloud computing infrastructure, one or more desktop computers, one or more laptop computers, one or more mobile computing devices, one or more kiosks, one or more input terminals, some combination thereof, or the like. In some embodiments, the data processing unit 104 may be configured to receive, processes, and/or transmit data.

In some embodiments, the data processing unit 104 may include a data processing unit cache 116. The data processing unit cache 116 may be configured to receive, store, and/or transmit data associated with the data processing unit 104. For example, the data processing unit cache 116 may comprise a temporary storage associated with the data processing unit 104. In some embodiments, the data processing unit 104 may include a data processing unit streaming queue 124. The data processing unit streaming queue 124 may be configured to receive, store, and/or transmit data associated with the data processing unit 104. For example, the data processing unit streaming queue 124 may be configured to transmit data to another component in the environment 100 (e.g., stream data). In some embodiments, the data processing unit 104 may include a data processing unit command queue 122. The data processing unit command queue 122 may be configured to receive and/or transmit data. For example, the data processing unit command queue 122 may be configured to receive data indicating a command associated with the optimized control system 112. Although the data processing unit cache 116, the data processing unit streaming queue 124, and the data processing unit command queue 122 are depicted as components of the data processing unit 104 in FIG. 1, it would be understood by one skilled in the field to which this disclosure pertains that the data processing unit 104, data processing unit cache 116, the data processing unit streaming queue 124, and the data processing unit command queue 122 may be separate components.

The environment 100 may include a database 106. The database 106 may be configured to receive, store, and/or transmit data. In some embodiments, the data may be received from the data publisher 102 and/or the data processing unit 104. In some embodiments, the database 106 may be a distributed database. In this regard, for example, the database 106 may include one or more database instances with each database instance configured to receive, store, and/or transmit data (e.g., each database instance is configured to receive, store, and/or transmit at least some of the data that the database 106 receives, stores, and/or transmits).

In some embodiments, the database 106 may include a data processing unit command queue 122. The database command queue 126 may be configured to receive and/or transmit data. For example, the database command queue 126 may be configured to receive data indicating a command associated with the optimized control system 112. Although the database command queue 126 is depicted as a component of the database 106 in FIG. 1, it would be understood by one skilled in the field to which this disclosure pertains that the database 106 and the database command queue 126 may be separate components.

Additionally, while FIG. 1 illustrates certain components as separate, standalone entities communicating directly with each other, various embodiments are not limited to this configuration. In other embodiments, one or more components may communicate over a network and/or share hardware or the like.

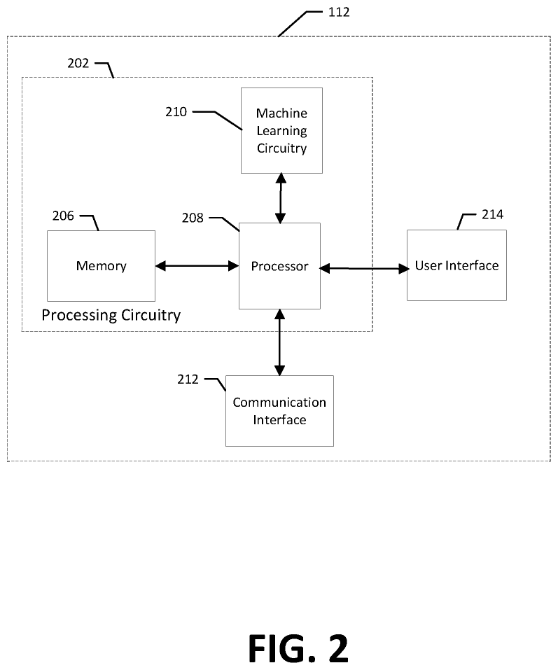

FIG. 2 illustrates a block diagram of the optimized control system 112 in accordance with some example embodiments. However, it should be noted that the components, devices, or elements illustrated in and described with respect to FIG. 2 below may not be mandatory and thus one or more may be omitted in certain embodiments. Additionally, some embodiments may include further or different components, devices, or elements beyond those illustrated in and described with respect to FIG. 2.

The optimized control system 112 may include or otherwise be in communication with processing circuitry 202 that is configurable to perform actions in accordance with one or more example embodiments disclosed herein. In this regard, the processing circuitry 202 may be configured to perform and/or control performance of one or more functionalities of the optimized control system 112 in accordance with various example embodiments, and thus may provide means for performing functionalities of the optimized control system 112 in accordance with various example embodiments. The processing circuitry 202 may be configured to perform data processing, application execution and/or other processing and management services according to one or more example embodiments. In some embodiments, the optimized control system 112 or a portion(s) or component(s) thereof, such as the processing circuitry 202, may be embodied as or comprise a chip or chip set. In other words, the optimized control system 112 or the processing circuitry 202 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The optimized control system 112 or the processing circuitry 202 may therefore, in some cases, be configured to implement an embodiment of the disclosure on a single chip or as a single “system on a chip.” As such, in some cases, a chip or chipset may constitute means for performing one or more operations for providing the functionalities described herein.

In some example embodiments, the processing circuitry 202 may include a processor 208 and, in some embodiments, such as that illustrated in FIG. 2, may further include memory 206 and machine learning circuitry 210. The processing circuitry 202 may be in communication with or otherwise control a communication interface 212 and/or a user interface 214. As such, the processing circuitry 202 may be embodied as a circuit chip (e.g., an integrated circuit chip) configured (e.g., with hardware, software or a combination of hardware and software) to perform operations described herein.

The processor 208 may be embodied in a number of different ways. For example, the processor 208 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. Although illustrated as a single processor, it will be appreciated that the processor 208 may comprise a plurality of processors. The plurality of processors may be in operative communication with each other and may be collectively configured to perform one or more functionalities of the optimized control system 112 as described herein. The plurality of processors may be embodied on a single computing device or distributed across a plurality of computing devices collectively configured to function as the optimized control system 112. In some example embodiments, the processor 208 may be configured to execute instructions stored in the memory 206 or otherwise accessible to the processor 208. As such, whether configured by hardware or by a combination of hardware and software, the processor 208 may represent an entity (e.g., physically embodied in circuitry-in the form of processing circuitry 202) capable of performing operations according to embodiments of the present disclosure while configured accordingly. Thus, for example, when the processor 208 is embodied as an ASIC, FPGA or the like, the processor 208 may be specifically configured hardware for conducting the operations described herein. Alternatively, as another example, when the processor 208 is embodied as an executor of software instructions, the instructions may specifically configure the processor 208 to perform one or more operations described herein.

In some example embodiments, the memory 206 may include one or more non-transitory memory devices such as, for example, volatile and/or non-volatile memory that may be either fixed or removable. In this regard, the memory 206 may comprise a non-transitory computer-readable storage medium. It will be appreciated that while the memory 206 is illustrated as a single memory, the memory 206 may comprise a plurality of memories. The plurality of memories may be embodied on a single computing device or may be distributed across a plurality of computing devices collectively configured to function as the optimized control system 112. The memory 206 may be configured to store information, data, applications, instructions and/or the like for enabling the optimized control system 112 to carry out various functions in accordance with one or more example embodiments. For example, the memory 206 may be configured to buffer input data for processing by the processor 208. Additionally or alternatively, the memory 206 may be configured to store instructions for execution by the processor 208. As yet another alternative, the memory 206 may include one or more databases that may store a variety of files, contents, or data sets. Among the contents of the memory 206, applications may be stored for execution by the processor 208 in order to carry out the functionality associated with each respective application. In some cases, the memory 206 may be in communication with one or more of the processor 208, communication interface 212, or the machine learning circuitry 210, or the user interface 214 via a bus(es) for passing information among components of the optimized control system 112.

In some example embodiments, the machine learning circuitry 210 may include hardware components designed or configured to request, receive, process, generate, and transmit data, data structures, control signals, and electronic information for executing a trained machine learning model. In some example embodiments, the memory 206 may be in communication with one or more of the memory 206, the processor 208, the communication interface 212, or the user interface 214 via a bus(es) for passing information among components of the optimized control system 112.

In some example embodiments, the optimized control system 112 may further include a communication interface 212. In some cases, the communication interface 212 may be any means such as a device or circuitry embodied in either hardware, or a combination of hardware and software that is configured to receive and/or transmit data from/to a network and/or any other device or circuitry in communication with the processing circuitry 202. Accordingly, the communication interface 212 may, for example, include an antenna (or multiple antennas) and supporting hardware and/or software for enabling communications with a wireless communication network (e.g., a wireless local area network, cellular network, and/or the like) and/or a communication modem or other hardware/software for supporting communication via cable, digital subscriber line (DSL), universal serial bus (USB), Ethernet or other methods.

In some example embodiments, the optimized control system 112 may further include a user interface 214. The user interface 214 may be in communication with the processing circuitry 202 to receive an indication of a user input at the user interface 214 (e.g., a user selection) and/or to provide an audible, visual, mechanical, and/or other output to the user. As such, the user interface 214 may include, for example, a keyboard, a mouse, a joystick, a display, a touch screen display, a microphone, a speaker, and/or other input/output mechanisms. As such, the user interface 214 may, in some example embodiments, provide means for a user to access and interact with the optimized control system 112 in accordance with various example embodiments.

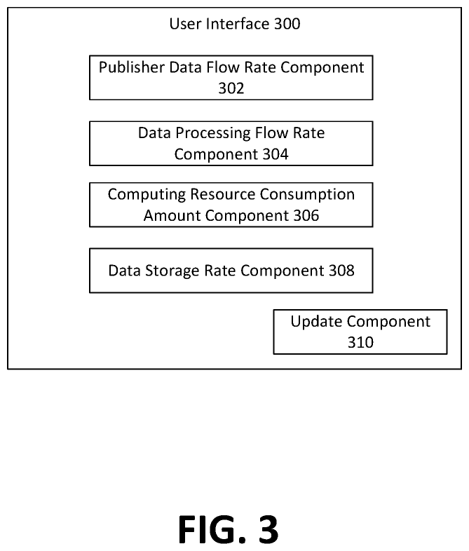

With reference to FIGS. 1-3, in some embodiments, the optimized control system 112 may be configured to receive monitoring data. In some embodiments, the monitoring data may represent operations of one or more of a data publisher 102, a data processing unit 104, and/or a database 106. In this regard, for example, the optimized control system 112 may be configured to receive the monitoring data from one or more of the data publisher 102, the data processing unit 104, and/or the database 106. In some embodiments, the monitoring data may be received by the optimized control system 112 in real-time. In some embodiments, the monitoring data may be received by the optimized control system 112 on a periodic basis (e.g., once per minute, once per hour, once per day, once per week, etc.). In some embodiments, the monitoring data may be received by the optimized control system 112 in response to a request by the optimized control system 112 for the monitoring data (e.g., the optimized control system 112 may request the monitoring data from the data publisher 102, the data processing unit 104, and/or the database 106).

In some embodiments, the data publisher 102 may be configured to receive publisher data from the computing device 118. In this regard, for example, the publisher data may be any type of data that the computing device is configured to generate, receive, and/or transmit. In some embodiments, for example, the publisher data may comprise sensor data. In this regard, for example, the computing device 118 may comprise a sensor configured to capture the publisher data. For example, the computing device 118 may comprise one or more of a heat sensor configured to capture heat data (e.g., the heat data is the publisher data), a gas sensor configured to capture gas data, a temperature sensor configured to capture temperature data, a humidity sensor configured to capture humidity data, a particulate matter sensor configured to capture particulate matter data, a vibration sensor configured to capture vibration data, an acceleration sensor configured to capture acceleration data, and/or the like.

In some embodiments, the data publisher 102 may be configured to receive publisher data from the computing device 118 in real-time. In this regard, for example, the data publisher 102 may be configured to receive publisher data from the computing device 118 as the computing device 118 generates, receives, and/or captures the publisher data. Additionally or alternatively, the data publisher 102 may be configured to receive publisher data from the computing device 118 on a periodic basis. In this regard, for example, the data publisher 102 may be configured to receive a batch of publisher data that the computing device 118 has accumulated (e.g., the data publisher 102 may receive a batch of the publisher data that the computing device 118 has accumulated since the last time that the data publisher 102 received publisher data from the computing device 118).

In some embodiments, the data publisher 102 may be configured to transmit publisher data to one or more other components of the environment 100. In this regard, for example, the data publisher 102 may be configured to transmit the publisher data to the data processing unit 104. In some embodiments, transmitting the publisher data to the data processing unit 104 may be performed by the data publisher streaming queue 120. In some embodiments, the data processing unit 104 may be configured to receive publisher data from the data publisher 102. In some embodiments, the processing unit may be configured to generate data processing data based at least in part on the publisher data. In this regard, for example, the data processing unit 104 may be configured to generate data processing data based at least in part on the publisher data by performing one or more types on processing on the publisher data. In some embodiments, for example, the data processing unit 104 may be configured to generate data processing data based at least in part on the publisher data by performing ontology processing on the publisher data. In this regard, for example, ontology processing may include associating metadata with the publisher metadata. Additionally or alternatively, the data processing unit 104 may be configured to generate data processing data based at least in part on the publisher data by performing normalization processing on the publisher data. In this regard, for example, normalization processing may include transforming the publisher data from a non-normalized format to a normalized format. Additionally or alternatively, the data processing unit 104 may be configured to generate data processing data based at least in part on the publisher data by performing interpolation processing on the publisher data. In this regard, for example, the publisher data may be incomplete (e.g., there are gaps in the publisher data). In some embodiments, interpolation processing may include completing the publisher data (e.g., filling in the gaps in the publisher data). Additionally or alternatively, the data processing unit 104 may be configured to generate data processing data based at least in part on the publisher data by performing trends processing on the publisher data. In this regard, for example, trends processing may include generating data processing data indicative of trends in the publisher data.

In some embodiments, the database 106 may be configured to receive data processing data from the data processing unit 104. In this regard, for example, the data processing unit 104 may be configured to transmit the data processing data to the database 106. In some embodiments, transmitting the data processing data to the database 106 may be performed by the data processing unit streaming queue 124. In some embodiments, the database 106 may be configured to store the data processing data. In some embodiments, the database 106 may be a time series database. In some embodiments, the database 106 may be a relational database. In some embodiments, the database 106 may be a graphical database.

In some embodiments, the monitoring data may include data indicating a publisher data flow rate. In some embodiments, the publisher data flow rate may be a rate at which the data publisher 102 may transmit publisher data to the data processing unit 104. For example, the publisher data flow rate may be 100 megabytes per second (e.g., the data publisher 102 may transmit 100 megabytes of publisher data per second to the data processing unit 104).

In some embodiments, the monitoring data may include data indicating a data processing flow rate. In some embodiments, the data processing flow rate may be a rate at which the data processing unit 104 may transmit data processing data to the database 106. For example, the data processing flow rate may be 80 megabytes per second (e.g., the data processing unit 104 may transmit 80 megabytes of data processing data per second to the database 106).

In some embodiments, the monitoring data may include data indicating a computing resource consumption amount. In some embodiments, the computing resource consumption amount may be an amount of computing resources used by the data processing unit 104 in generating the data processing data based at least in part on the publisher data. For example, the computing resource consumption amount may be an amount of processing power and/or memory allocation used by the data processing unit 104. As another example, the computing resource consumption amount may be a number of computing nodes (e.g., computing instances) used by the data processing unit 104.

In some embodiments, the monitoring data may include data indicating a data storage rate. In some embodiments, the data storage rate may be a rate at which the database 106 may store data processing data in the database 106. For example, the data storage rate may be 100 megabytes per second (e.g., the database 106 may store 100 megabytes of data processing data per second).

In some embodiments, the optimized control system 112 may be configured to determine a first data processing error associated with the data publisher 102 and/or the data processing unit 104. In some embodiments, the first data processing error may be based at least in part on the monitoring data. In some embodiments, the first data processing error may indicate that the publisher data flow rate is greater than a rate at which the data processing unit 104 can process the publisher data based at least in part on the computing resource consumption amount associated with the data processing unit 104. Said differently, the first data processing error may indicate that the data publisher 102 is transmitting publisher data to the data processing unit 104 at a greater rate than the data processing unit 104 can process the publisher data (e.g., generate data processing data from) based on the computing resource consumption amount associated with the data processing unit 104. For example, the first data processing error may indicate that the data publisher 102 is transmitting 50 megabytes of publisher data per second to the data processing unit 104 but, based at least in part on the computing resource consumption amount associated with the data processing unit 104, the data processing unit 104 may only be able to process 25 megabytes of publisher data per second (e.g., the data processing unit 104 may only be able to generate data processing data for 25 megabytes of publisher data per second).

In some embodiments, the optimized control system 112 may be configured to cause a first controller 108 to control the data publisher 102 and/or the data processing unit 104 based at least in part on the first data processing error. In some embodiments, casing the first controller 108 to control the data publisher 102 and/or the data processing unit 104 based at least in part on the first data processing error may include causing at least one command signal to be sent to the data publisher command queue 128 and/or the data processing unit command queue 122. For example, the optimized control system 112 may be configured to cause the first controller 108 to control the data publisher 102 and/or the data processing unit 104 when the first data processing error indicates that the publisher data flow rate is greater than a rate at which the data processing unit 104 can process the publisher data based at least in part on the computing resource consumption amount associated with the data processing unit 104.

For example, the optimized control system 112 may be configured to cause the first controller 108 to control the data publisher 102 such that the publisher data flow rate is decreased. In some embodiments, the publisher data flow rate may be decreased by the data publisher 102 transmitting at least a portion of the publisher data to a data publisher cache 114. In this regard, for example, at least a portion of the publisher data may be stored in the data publisher cache 114 until the data processing unit 104 is able to process the publisher data stored in the data publisher cache 114. As such, the optimized control system 112, at least in part by causing the first controller 108 to control the data publisher 102, may be able to prevent the data processing unit 104 from becoming overwhelmed such that processing delays and/or processing errors associated with the data processing unit 104 are prevented (e.g., by decreasing the amount of publisher data that the data processing unit 104 must process, at least temporarily).

Additionally or alternatively, as another example, the optimized control system 112 may be configured to cause the first controller 108 to control the data processing unit 104 such that the computing resource consumption amount associated with the data processing unit 104 is increased. In some embodiments, the computing resource consumption amount associated with the data processing unit 104 may be increased by the data processing unit 104 allocating more processing power and/or memory to the processing of the publisher data (e.g., for the generation of the data processing data based at least in part on the publisher data). In some embodiments, the computing resource consumption amount associated with the data processing unit 104 may be increased by the data processing unit 104 increasing the number of computing nodes used by the data processing unit 104. As such, the optimized control system 112, at least in part by causing the first controller 108 to control the data publisher 102, may be able to prevent the data processing unit 104 from becoming overwhelmed such that processing delays and/or processing errors associated with the data processing unit 104 are prevented (e.g., by increasing the computing resource consumption amount such that the data processing unit 104 can process more publisher data).

In some embodiments, the first data processing error may indicate that the publisher data flow rate is less than a rate at which the data processing unit 104 can process the publisher data based at least in part on the computing resource consumption amount associated with the data processing unit 104. Said differently, the first data processing error may indicate that the data publisher 102 is transmitting publisher data to the data processing unit 104 at a rate less than the data processing unit 104 can process the publisher data (e.g., generate data processing data from) based on the computing resource consumption amount associated with the data processing unit 104. For example, the first data processing error may indicate that the data publisher 102 is transmitting 50 megabytes of publisher data per second to the data processing unit 104 but, based at least in part on the computing resource consumption amount associated with the data processing unit 104, the data processing unit 104 may be able to process 75 megabytes of publisher data per second (e.g., the data processing unit 104 may be able to generate data processing data for 75 megabytes of publisher data per second).

In some embodiments, the optimized control system 112 may be configured to cause the first controller 108 to control the data publisher 102 and/or the data processing unit 104 based at least in part on the first data processing error. In some embodiments, casing the first controller to control the data publisher 102 and/or the data processing unit 104 based at least in part on the first data processing error may include causing at least one command signal to be sent to the data publisher command queue and/or the data processing unit command queue. For example, the optimized control system 112 may be configured to cause the first controller 108 to control the data publisher 102 and/or the data processing unit 104 when the first data processing error indicates that the publisher data flow rate is less than a rate at which the data processing unit 104 can process the publisher data based at least in part on the computing resource consumption amount associated with the data processing unit 104.

For example, the optimized control system 112 may be configured to cause the first controller 108 to control the data publisher 102 such that the publisher data flow rate is increased. In some embodiments, the publisher data flow rate may be increased by the data publisher 102 requesting that the computing device 118 transmit more publisher data to the data publisher 102. For example, for publisher data that the computing device 118 transmits to the data publisher 102 on a periodic basis (e.g., once per week), the data publisher 102 may request that the computing device 118 transmits before the next periodic transmittal time. As another example, the publisher data flow rate may be increased by the data publisher 102 causing at least a portion of the publisher data stored in the data publisher cache 114 to be transmitted to the data processing unit 104. As such, the optimized control system 112, at least in part by causing the first controller 108 to control the data publisher 102, may be able to ensure that the computing resource consumption amount associated with the data processing unit 104 is being efficiently used (e.g., allocated processing power and/or memory is not idle, allocated computing nodes are not idle, etc.).

Additionally or alternatively, as another example, the optimized control system 112 may be configured to cause the first controller 108 to control the data processing unit 104 such that the computing resource consumption amount associated with the data processing unit 104 is decreased. In some embodiments, the computing resource consumption amount associated with the data processing unit 104 may be decreased by the data processing unit 104 reducing its allocation of processing power and/or memory associated with the processing of the publisher data (e.g., for the generation of the data processing data based at least in part on the publisher data). In some embodiments, the computing resource consumption amount associated with the data processing unit 104 may be decreased by the data processing unit 104 decreasing the number of computing nodes used by the data processing unit 104. As such, the optimized control system 112, at least in part by causing the first controller 108 to control the data publisher 102, may be able to ensure that the computing resource consumption amount associated with the data processing unit 104 is not greater than necessary to perform the processing of the publisher data by the data processing unit 104.

In some embodiments, the optimized control system 112 may be configured to determine a second data processing error associated with the data processing unit 104 and/or the database 106. In some embodiments, the second data processing error may be based at least in part on the monitoring data. In some embodiments, the second data processing error may indicate that the data processing flow rate is greater than a rate at which the database 106 can store the data processing data based at least in part on the data storage rate. Said differently, the second data processing error may indicate that the data processing unit 104 is transmitting data processing data to the database 106 at a greater rate than the database 106 can store the data processing data. For example, the second data processing error may indicate that the data processing unit 104 is transmitting 100 megabytes of data processing data per second to the database 106 but, based at least in part on the data storage rate, the database 106 may only be able to store 50 megabytes of data processing data per second.

In some embodiments, the optimized control system 112 may be configured to cause a second controller 110 to control the data processing unit 104 and/or the database 106 based at least in part on the second data processing error. In some embodiments, casing the second controller 110 to control the data processing unit 104 and/or the database 106 based at least in part on the second data processing error may include causing at least one command signal to be sent to the data processing unit command queue 122 and/or the database command queue 126. For example, the optimized control system 112 may be configured to cause the second controller 110 to control the data processing unit 104 and/or the database 106 when the second data processing error indicates that the data processing flow rate is greater than a rate at which the database 106 can store the data processing data based at least in part on the data storage rate.

For example, the optimized control system 112 may be configured to cause the second controller 110 to control the data processing unit 104 such that the data processing flow rate is decreased. In some embodiments, the data processing flow rate may be decreased by the data processing unit 104 transmitting at least a portion of the data processing data to a data processing unit cache 116. In this regard, for example, at least a portion of the data processing data may be stored in the data processing unit cache 116 until the database 106 is able to store the data processing data stored in the data processing unit cache 116 in the database 106. As such, the optimized control system 112, at least in part by causing the second controller 110 to control the data processing unit 104, may be able to prevent the database 106 from becoming overwhelmed such that storage delays and/or storage errors (e.g., data processing data may be improperly stored such that it is corrupted or stored in the wrong location) associated with the database 106 are prevented (e.g., by decreasing the amount of data processing data that the database 106 must store, at least temporarily).

Additionally or alternatively, as another example, the optimized control system 112 may be configured to cause the second controller 110 to control the database 106 such that the data storage rate is increased. In some embodiments, for example, the data storage rate may be increased by the database 106 allocating a greater portion of the database 106 to the data processing data. As another example, when the database 106 is a distributed database, the data storage rate may be increased by allocating a greater number of database instances of the database 106 to the data processing data. As such, the optimized control system 112, at least in part by causing the second controller 110 to control the database 106, may be able to prevent the database 106 from becoming overwhelmed such that storage delays and/or storage errors (e.g., data processing data may be improperly stored such that it is corrupted or stored in the wrong location) associated with the database 106 are prevented (e.g., by allocating a greater portion of the database 106 to the data processing data).

In some embodiments, the second data processing error may indicate that the data processing flow rate is less than a rate at which the database 106 can store the data processing data based at least in part on the data storage rate. Said differently, the second data processing error may indicate that the data processing unit 104 is transmitting data processing data to the database 106 at rate less than the database 106 can store the data processing data. For example, the second data processing error may indicate that the data processing unit 104 is transmitting 50 megabytes of data processing data per second to the database 106 but, based at least in part on the data storage rate, the database 106 may be able to store 75 megabytes of data processing data per second.

In some embodiments, the optimized control system 112 may be configured to cause the second controller 110 to control the data processing unit 104 and/or the database 106 based at least in part on the second data processing error. In some embodiments, casing the second controller to control the data processing unit 104 and/or the database 106 based at least in part on the second data processing error may include causing at least one command signal to be sent to the data processing unit command queue 122 and/or the database command queue 126. For example, the optimized control system 112 may be configured to cause the second controller 110 to control the data processing unit 104 and/or the database 106 when the second data processing error indicates that the data processing flow rate is less than a rate at which the database 106 can store the data processing data based at least in part on the data storage rate.

For example, the optimized control system 112 may be configured to cause the second controller 110 to control the data processing unit 104 such that the data processing flow rate is increased. In some embodiments, the data processing flow rate may be increased by the data processing unit 104 causing at least a portion of the data processing data stored in the data processing unit cache 116 to be transmitted to the database 106. As such, the optimized control system 112, at least in part by causing the second controller 110 to control the data processing unit 104, may be able to that the database 106 is efficiently used by providing the database 106 with enough data processing data such that the database 106 can store data processing data at the data storage rate associated with the database 106.

Additionally or alternatively, as another example, the optimized control system 112 may be configured to cause the second controller 110 to control the database 106 such that the data storage rate is decreased. In some embodiments, the data storage rate may be decreased by the database 106 allocating a smaller portion of the database 106 to the data processing data. As another example, when the database 106 is a distributed database, the data storage rate may be decreased by allocating a fewer number of database instances of the database 106 to the data processing data. As such, the optimized control system 112, at least in part by causing the second controller 110 to control the database 106, may be able to ensure that the database 106 efficiently uses the storage space in the database 106.

In some embodiments, the first controller 108 may be a first proportional-integral-derivative (PID) controller. In this regard, the first controller 108 may be configured to control the data publisher 102 and/or the data processing unit 104 using PID control (e.g., control the publisher data flow rate using PID control). In some embodiments, when the first controller 108 is a first PID controller, the first controller 108 may be configured to control the data publisher 102 and/or the data processing unit 104 using a first PID control equation (PID_{ce1}), which is illustrated below as equation (1):

$${PID}_{ce 1} = {KD}_{fdpe 1} + \int {D}_{fdpe 1} + \frac{d}{dt} {D}_{fdpe 1} , \qquad ( 1 )$$

where D_{fdpe1} is representative of the first data processing error. For example, D_{fape1} may indicate that the publisher data flow rate is greater than a rate at which the data processing unit 104 can process the publisher data based at least in part on the computing resource consumption amount associated with the data processing unit 104. As another example, D_{fdpe1} may indicate that the publisher data flow rate is less than a rate at which the data processing unit 104 can process the publisher data based at least in part on the computing resource consumption amount associated with the data processing unit 104.

In some embodiments, the second controller 110 may be a second proportional-integral-derivative (PID) controller. In this regard, the second controller 110 may be configured to control the data processing unit 104 and/or the database 106 using PID control. In some embodiments, when the second controller 110 is a second PID controller, the second controller 110 may be configured to control the data processing unit 104 and/or the database 106 using a second PID control equation (PID_{ce2}), which is illustrated below as equation (2):

$${PID}_{ce 2} = {KD}_{fdpe 2} + \int {D}_{fdpe 2} + \frac{d}{dt} {D}_{fdpe 2} , \qquad ( 2 )$$

where D_{fdpe2} is representative of the second data processing error. For example, D_{fdpe2} may indicate that the data processing flow rate is greater than a rate at which the database 106 can store the data processing data based at least in part on the data storage rate. As another example, D_{fdpe2} may indicate that the data processing flow rate is less than a rate at which the database 106 can store the data processing data based at least in part on the data storage rate.

In some embodiments, the optimized control system 112 may be configured to cause a user interface 300 to be displayed. In some embodiments, the user interface 300 may include a publisher data flow rate component 302. The publisher data flow rate component 302 may be configured to display the publisher data flow rate. For example, the publisher data flow rate component 302 may be configured to display that the publisher data flow rate is 100 megabytes per second. In some embodiments, the user interface 300 may include a data processing flow rate component 304. The data processing flow rate component 304 may be configured to display the data processing flow rate. For example, the data processing flow rate component 304 may be configured to display that the data processing flow rate is 50 megabytes per second. In some embodiments, the user interface 300 may include a computing resource consumption amount component 306. The computing resource consumption amount component 306 may be configured to display the computing resource consumption amount associated with the data processing unit 104. For example, the computing resource consumption amount component 306 may be configured to display that the computing resource computing amount is 5 computing nodes. In some embodiments, the user interface 300 may include a data storage rate component 308. The data storage rate component 308 may be configured to display the data storage rate. For example, the data storage rate component 308 may be configured to display that the data storage rate is 75 megabytes per second.

In some embodiments, the user interface 300 may be configured to be updated in real-time. In this regard, for example, the user interface 300 may be updated as at least one of the publisher data flow rate, the data processing flow rate, the computing resource consumption amount, and/or the data storage rate changes. For example, if the publisher data flow rate changes from 50 megabytes per second to 75 megabytes per second, the publisher data flow rate component 302 may be updated in real-time (e.g., as the publisher data flow rate changes). In some embodiments, the user interface 300 may be configured to be updated each time the optimized control system 112 causes the first controller 108 to control the data publisher 102 or the data processing unit 104 and/or causes the second controller 110 to control the data processing unit 104 or the database 106. For example, if the optimized control system 112 causes the second controller 110 to control the database 106 such that the data storage rate decreases, the data storage rate component 308 may be updated. In some embodiments, the user interface 300 may be configured to be updated in response to an update request received via an update component 310 displayed on the user interface 300.

### Example Methods

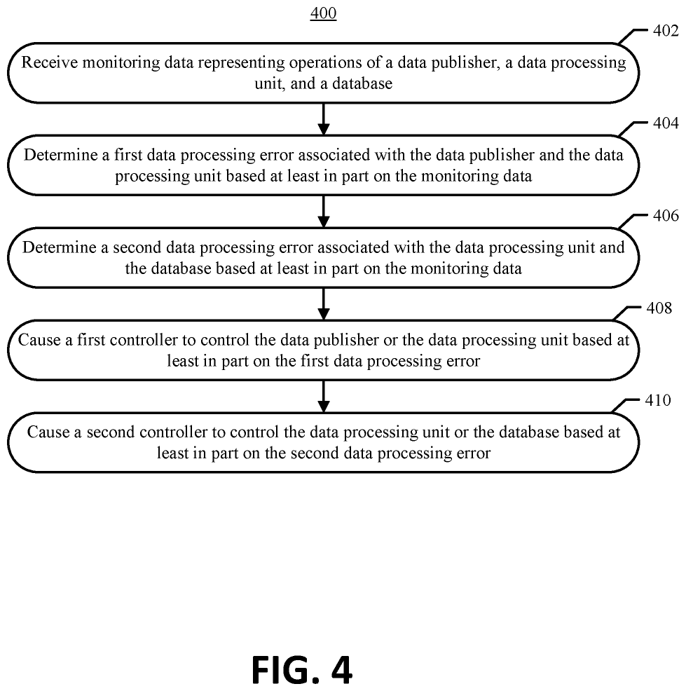

Referring now to FIG. 4, a flowchart providing an example computer-implemented method 400 is illustrated. In this regard, FIG. 4 illustrates operations that may be performed by one or more of the optimized control system 112, the computing device 118, the data publisher 102, the data publisher cache 114, the data processing unit 104, the data processing unit cache 116, the database 106, the first controller 108, the second controller 110, and/or the like. In some embodiments, the example computer-implemented method 400 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the computer-implemented method 400.

As shown in block 402, the computer-implemented method 400 may include receiving monitoring data representing operations of a data publisher, a data processing unit, and a database. As described above, in some embodiments, the monitoring data may represent operations of one or more of a data publisher, a data processing unit, and/or a database. In this regard, for example, the monitoring data may be received from one or more of the data publisher, the data processing unit, and/or the database. In some embodiments, the monitoring data may be received in real-time.

In some embodiments, the monitoring data may be received on a periodic basis (e.g., once per minute, once per hour, once per day, once per week, etc.). In some embodiments, the monitoring data may be received in response to a request for the monitoring data.

In some embodiments, the data publisher may be configured to receive publisher data from the computing device. In this regard, for example, the publisher data may be any type of data that the computing device is configured to generate, receive, and/or transmit. In some embodiments, for example, the publisher data may comprise sensor data. In this regard, for example, the computing device may comprise a sensor configured to capture the publisher data. For example, the computing device may comprise one or more of a heat sensor configured to capture heat data (e.g., the heat data is the publisher data), a gas sensor configured to capture gas data, a temperature sensor configured to capture temperature data, a humidity sensor configured to capture humidity data, a particulate matter sensor configured to capture particulate matter data, a vibration sensor configured to capture vibration data, an acceleration sensor configured to capture acceleration data, and/or the like.

In some embodiments, the data publisher may be configured to receive publisher data from the computing device in real-time. In this regard, for example, the data publisher may be configured to receive publisher data from the computing device as the computing device generates, receives, and/or captures the publisher data. Additionally or alternatively, the data publisher may be configured to receive publisher data from the computing device on a periodic basis. In this regard, for example, the data publisher may be configured to receive a batch of publisher data that the computing device has accumulated (e.g., the data publisher may receive a batch of the publisher data that the computing device has accumulated since the last time that the data publisher received publisher data from the computing device).

In some embodiments, the data publisher may be configured to transmit publisher data to one or more other components of the environment. In this regard, for example, the data publisher may be configured to transmit the publisher data to the data processing unit. In some embodiments, transmitting the publisher data to the data processing unit may be performed by the data publisher streaming queue. In some embodiments, the data processing unit may be configured to receive publisher data from the data publisher. In some embodiments, the processing unit may be configured to generate data processing data based at least in part on the publisher data. In this regard, for example, the data processing unit may be configured to generate data processing data based at least in part on the publisher data by performing one or more types on processing on the publisher data. In some embodiments, for example, the data processing unit may be configured to generate data processing data based at least in part on the publisher data by performing ontology processing on the publisher data. In this regard, for example, ontology processing may include associating metadata with the publisher metadata. Additionally or alternatively, the data processing unit may be configured to generate data processing data based at least in part on the publisher data by performing normalization processing on the publisher data. In this regard, for example, normalization processing may include transforming the publisher data from a non-normalized format to a normalized format. Additionally or alternatively, the data processing unit may be configured to generate data processing data based at least in part on the publisher data by performing interpolation processing on the publisher data. In this regard, for example, the publisher data may be incomplete (e.g., there are gaps in the publisher data). In some embodiments, interpolation processing may include completing the publisher data (e.g., filling in the gaps in the publisher data). Additionally or alternatively, the data processing unit may be configured to generate data processing data based at least in part on the publisher data by performing trends processing on the publisher data. In this regard, for example, trends processing may include generating data processing data indicative of trends in the publisher data.

In some embodiments, the database may be configured to receive data processing data from the data processing unit. In this regard, for example, the data processing unit may be configured to transmit the data processing data to the database. In some embodiments, transmitting the data processing data to the database may be performed by the data processing unit streaming queue. In some embodiments, the database may be configured to store the data processing data. In some embodiments, the database may be a time series database. In some embodiments, the database may be a relational database. In some embodiments, the database may be a graphical database.

In some embodiments, the monitoring data may include data indicating a publisher data flow rate. In some embodiments, the publisher data flow rate may be a rate at which the data publisher may transmit publisher data to the data processing unit. For example, the publisher data flow rate may be 100 megabytes per second (e.g., the data publisher may transmit 100 megabytes of publisher data per second to the data processing unit).

In some embodiments, the monitoring data may include data indicating a data processing flow rate. In some embodiments, the data processing flow rate may be a rate at which the data processing unit may transmit data processing data to the database. For example, the data processing flow rate may be 80 megabytes per second (e.g., the data processing unit may transmit 80 megabytes of data processing data per second to the database).

In some embodiments, the monitoring data may include data indicating a computing resource consumption amount. In some embodiments, the computing resource consumption amount may be an amount of computing resources used by the data processing unit in generating the data processing data based at least in part on the publisher data. For example, the computing resource consumption amount may be an amount of processing power and/or memory allocation used by the data processing unit. As another example, the computing resource consumption amount may be a number of computing nodes (e.g., computing instances) used by the data processing unit.

In some embodiments, the monitoring data may include data indicating a data storage rate. In some embodiments, the data storage rate may be a rate at which the database may store data processing data in the database. For example, the data storage rate may be 100 megabytes per second (e.g., the database may store 100 megabytes of data processing data per second).

As shown in block 404, the computer-implemented method 400 may include determining a first data processing error associated with the data publisher and the data processing unit based at least in part on the monitoring data. As described above, in some embodiments, a first data processing error associated with the data publisher and/or the data processing unit may be determined. In some embodiments, the first data processing error may be based at least in part on the monitoring data. In some embodiments, the first data processing error may indicate that the publisher data flow rate is greater than a rate at which the data processing unit can process the publisher data based at least in part on the computing resource consumption amount associated with the data processing unit. Said differently, the first data processing error may indicate that the data publisher is transmitting publisher data to the data processing unit at a greater rate than the data processing unit can process the publisher data (e.g., generate data processing data from) based on the computing resource consumption amount associated with the data processing unit. For example, the first data processing error may indicate that the data publisher is transmitting 50 megabytes of publisher data per second to the data processing unit but, based at least in part on the computing resource consumption amount associated with the data processing unit, the data processing unit may only be able to process 25 megabytes of publisher data per second (e.g., the data processing unit may only be able to generate data processing data for 25 megabytes of publisher data per second).

In some embodiments, the first data processing error may indicate that the publisher data flow rate is less than a rate at which the data processing unit can process the publisher data based at least in part on the computing resource consumption amount associated with the data processing unit. Said differently, the first data processing error may indicate that the data publisher is transmitting publisher data to the data processing unit at a rate less than the data processing unit can process the publisher data (e.g., generate data processing data from) based on the computing resource consumption amount associated with the data processing unit. For example, the first data processing error may indicate that the data publisher is transmitting 50 megabytes of publisher data per second to the data processing unit but, based at least in part on the computing resource consumption amount associated with the data processing unit, the data processing unit may be able to process 75 megabytes of publisher data per second (e.g., the data processing unit may be able to generate data processing data for 75 megabytes of publisher data per second).

As shown in block 406, the computer-implemented method 400 may include determining a second data processing error associated with the data processing unit and the database based at least in part on the monitoring data. As described above, in some embodiments, a second data processing error associated with the data processing unit and/or the database may be determined. In some embodiments, the second data processing error may be based at least in part on the monitoring data. In some embodiments, the second data processing error may indicate that the data processing flow rate is greater than a rate at which the database can store the data processing data based at least in part on the data storage rate. Said differently, the second data processing error may indicate that the data processing unit is transmitting data processing data to the database at a greater rate than the database can store the data processing data. For example, the second data processing error may indicate that the data processing unit is transmitting 100 megabytes of data processing data per second to the database but based at least in part on the data storage rate, the database may only be able to store 50 megabytes of data processing data per second.

In some embodiments, the second data processing error may indicate that the data processing flow rate is less than a rate at which the database can store the data processing data based at least in part on the data storage rate. Said differently, the second data processing error may indicate that the data processing unit is transmitting data processing data to the database at rate less than the database can store the data processing data. For example, the second data processing error may indicate that the data processing unit is transmitting 50 megabytes of data processing data per second to the database but based at least in part on the data storage rate, the database may be able to store 75 megabytes of data processing data per second.

As shown in block 408, the computer-implemented method 400 may include causing a first controller to control the data publisher or the data processing unit based at least in part on the first data processing error. As described above, in some embodiments, a first controller may be caused to control the data publisher and/or the data processing unit based at least in part on the first data processing error. For example, the first controller may be caused to control the data publisher and/or the data processing unit when the first data processing error indicates that the publisher data flow rate is greater than a rate at which the data processing unit can process the publisher data based at least in part on the computing resource consumption amount associated with the data processing unit.

For example, the first controller may be caused to control the data publisher such that the publisher data flow rate is decreased. In some embodiments, the publisher data flow rate may be decreased by the data publisher transmitting at least a portion of the publisher data to a data publisher cache. In this regard, for example, at least a portion of the publisher data may be stored in the data publisher cache until the data processing unit is able to process the publisher data stored in the data publisher cache. As such, by causing the first controller to control the data publisher, the data processing unit may be prevented from becoming overwhelmed such that processing delays and/or processing errors associated with the data processing unit are prevented (e.g., by decreasing the amount of publisher data that the data processing unit must process, at least temporarily).

Additionally or alternatively, as another example, the first controller may be caused to control the data processing unit such that the computing resource consumption amount associated with the data processing unit is increased. In some embodiments, the computing resource consumption amount associated with the data processing unit may be increased by the data processing unit allocating more processing power and/or memory to the processing of the publisher data (e.g., for the generation of the data processing data based at least in part on the publisher data). In some embodiments, the computing resource consumption amount associated with the data processing unit may be increased by the data processing unit increasing the number of computing nodes used by the data processing unit. As such, by causing the first controller to control the data publisher, the data processing unit may be prevented from becoming overwhelmed such that processing delays and/or processing errors associated with the data processing unit are prevented (e.g., by increasing the computing resource consumption amount such that the data processing unit can process more publisher data).

In some embodiments, the first controller may be caused to control the data publisher and/or the data processing unit based at least in part on the first data processing error. For example, the first controller may be caused to control the data publisher and/or the data processing unit when the first data processing error indicates that the publisher data flow rate is less than a rate at which the data processing unit can process the publisher data based at least in part on the computing resource consumption amount associated with the data processing unit.

For example, the first controller may be caused to control the data publisher such that the publisher data flow rate is increased. In some embodiments, the publisher data flow rate may be increased by the data publisher requesting that the computing device transmit more publisher data to the data publisher. For example, for publisher data that the computing device transmits to the data publisher on a periodic basis (e.g., once per week), the data publisher may request that the computing device transmits before the next periodic transmittal time. As another example, the publisher data flow rate may be increased by the data publisher causing at least a portion of the publisher data stored in the data publisher cache to be transmitted to the data processing unit. As such, at least in part by causing the first controller to control the data publisher, it may be ensured that the computing resource consumption amount associated with the data processing unit is being efficiently used (e.g., allocated processing power and/or memory is not idle, allocated computing nodes are not idle, etc.).

Additionally or alternatively, as another example, the first controller may be caused to control the data processing unit such that the computing resource consumption amount associated with the data processing unit is decreased. In some embodiments, the computing resource consumption amount associated with the data processing unit may be decreased by the data processing unit reducing its allocation of processing power and/or memory associated with the processing of the publisher data (e.g., for the generation of the data processing data based at least in part on the publisher data). In some embodiments, the computing resource consumption amount associated with the data processing unit may be decreased by the data processing unit decreasing the number of computing nodes used by the data processing unit. As such, at least in part by causing the first controller to control the data publisher, it may be ensured that the computing resource consumption amount associated with the data processing unit is not greater than necessary to perform the processing of the publisher data by the data processing unit.

As shown in block 410, the computer-implemented method 400 may include causing a second controller to control the data processing unit or the database based at least in part on the second data processing error. As described above, in some embodiments, a second controller may be caused to control the data processing unit and/or the database based at least in part on the second data processing error. For example, the second controller may be caused to control the data processing unit and/or the database when the second data processing error indicates that the data processing flow rate is greater than a rate at which the database can store the data processing data based at least in part on the data storage rate.

For example, the second controller may be caused to control the data processing unit such that the data processing flow rate is decreased. In some embodiments, the data processing flow rate may be decreased by the data processing unit transmitting at least a portion of the data processing data to a data processing unit cache. In this regard, for example, at least a portion of the data processing data may be stored in the data processing unit cache until the database is able to store the data processing data stored in the data processing unit cache in the database. As such, at least in part by causing the second controller to control the data processing unit, the database may be prevented from becoming overwhelmed such that storage delays and/or storage errors (e.g., data processing data may be improperly stored such that it is corrupted or stored in the wrong location) associated with the database are prevented (e.g., by decreasing the amount of data processing data that the database must store, at least temporarily).

Additionally or alternatively, as another example, the second controller may be caused to control the database such that the data storage rate is increased. In some embodiments, the data storage rate may be increased by the database allocating a greater portion of the database to the data processing data. As another example, when the database is a distributed database, the data storage rate may be increased by allocating a greater number of database instances of the database to the data processing data. As such, at least in part by causing the second controller to control the database, the database may be prevented from becoming overwhelmed such that storage delays and/or storage errors (e.g., data processing data may be improperly stored such that it is corrupted or stored in the wrong location) associated with the database are prevented (e.g., by allocating a greater portion of the database to the data processing data).

In some embodiments, the second controller may be caused to control the data processing unit and/or the database based at least in part on the second data processing error. For example, the second controller may be caused to control the data processing unit and/or the database when the second data processing error indicates that the data processing flow rate is less than a rate at which the database can store the data processing data based at least in part on the data storage rate.

For example, the second controller may be caused to control the data processing unit such that the data processing flow rate is increased. In some embodiments, the data processing flow rate may be increased by the data processing unit causing at least a portion of the data processing data stored in the data processing unit cache to be transmitted to the database. As such, at least in part by causing the second controller to control the data processing unit, the database may be able to be efficiently used by providing the database with enough data processing data such that the database can store data processing data at the data storage rate associated with the database.

Additionally or alternatively, as another example, the second controller may be caused to control the database such that the data storage rate is decreased. In some embodiments, the data storage rate may be decreased by the database allocating a smaller portion of the database to the data processing data. As another example, when the database is a distributed database, the data storage rate may be decreased by allocating a fewer number of database instances of the database to the data processing data. As such, at least in part by causing the second controller to control the database, it may be ensured that the database efficiently uses the storage space in the database.

In some embodiments, the first controller may be a first proportional-integral-derivative (PID) controller. In this regard, the first controller may be configured to control the data publisher and/or the data processing unit using PID control (e.g., control the publisher data flow rate using PID control). In some embodiments, when the first controller is a first PID controller, the first controller may be configured to control the data publisher and/or the data processing unit using a first PID control equation (PID_{ce1}), which is illustrated below as equation (1):

$${PID}_{ce 1} = {KD}_{fdpe 1} + \int {D}_{fdpe 1} + \frac{d}{dt} {D}_{fdpe 1} , \qquad ( 1 )$$

where D_{fdpe1} is representative of the first data processing error. For example, D_{fdpe1} may indicate that the publisher data flow rate is greater than a rate at which the data processing unit can process the publisher data based at least in part on the computing resource consumption amount associated with the data processing unit. As another example, D_{fdpe1} may indicate that the publisher data flow rate is less than a rate at which the data processing unit can process the publisher data based at least in part on the computing resource consumption amount associated with the data processing unit.

In some embodiments, the second controller may be a second proportional-integral-derivative (PID) controller. In this regard, the second controller may be configured to control the data processing unit and/or the database using PID control. In some embodiments, when the second controller is a second PID controller, the second controller may be configured to control the data processing unit and/or the database using a second PID control equation (PID_{ce2}), which is illustrated below as equation (2):

$${PID}_{ce 2} = {KD}_{fdpe 2} + \int {D}_{fdpe 2} + \frac{d}{dt} {D}_{fdpe 2} , \qquad ( 2 )$$

where D_{fdpe2} is representative of the second data processing error. For example, D_{fdpe2} may indicate that the data processing flow rate is greater than a rate at which the database can store the data processing data based at least in part on the data storage rate. As another example, D_{fdpe2} may indicate that the data processing flow rate is less than a rate at which the database can store the data processing data based at least in part on the data storage rate.

Operations and/or functions of the present disclosure have been described herein, such as in flowcharts. As will be appreciated, computer program instructions may be loaded onto a computer or other programmable apparatus (e.g., hardware) to produce a machine, such that the resulting computer or other programmable apparatus implements the operations and/or functions described in the flowchart blocks herein. These computer program instructions may also be stored in a computer-readable memory that may direct a computer, processor, or other programmable apparatus to operate and/or function in a particular manner, such that the instructions stored in the computer-readable memory produce an article of manufacture, the execution of which implements the operations and/or functions described in the flowchart blocks. The computer program instructions may also be loaded onto a computer, processor, or other programmable apparatus to cause a series of operations to be performed on the computer, processor, or other programmable apparatus to produce a computer-implemented process such that the instructions executed on the computer, processor, or other programmable apparatus provide operations for implementing the functions and/or operations specified in the flowchart blocks. The flowchart blocks support combinations of means for performing the specified operations and/or functions and combinations of operations and/or functions for performing the specified operations and/or functions. It will be understood that one or more blocks of the flowcharts, and combinations of blocks in the flowcharts, can be implemented by special purpose hardware-based computer systems which perform the specified operations and/or functions, or combinations of special purpose hardware with computer instructions.

While this specification contains many specific embodiments and implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

While operations and/or functions are illustrated in the drawings in a particular order, this should not be understood as requiring that such operations and/or functions be performed in the particular order shown or in sequential order, or that all illustrated operations be performed, to achieve desirable results. In certain circumstances, operations and/or functions in alternative ordering may be advantageous. In some cases, the actions recited in the claims may be performed in a different order and still achieve desirable results. Thus, while particular embodiments of the subject matter have been described, other embodiments are within the scope of the following claims.

While this specification contains many specific embodiment and implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are illustrated in the drawings in a particular order, this should not be understood as requiring that such operations be performed in the particular order shown or in sequential order, or that all illustrated operations be performed, to achieve desirable results. In certain circumstances, operations in alternative ordering may be advantageous. In some cases, the actions recited in the claims may be performed in a different order and still achieve desirable results.

That which is claimed:

1. A computer-implemented method comprising:
receiving monitoring data representing operations of a data publisher, a data processing unit, and a database;
determining a first data processing error associated with the data publisher and the data processing unit based at least in part on the monitoring data;
determining a second data processing error associated with the data processing unit and the database based at least in part on the monitoring data;
causing a first controller to control the data publisher or the data processing unit based at least in part on the first data processing error; and
causing a second controller to control the data processing unit or the database based at least in part on the second data processing error.

2. The computer-implemented method of claim 1, wherein the first controller is a first proportional-integral-derivative (PID) controller and the second controller is a second PID controller.

3. The computer-implemented method of claim 1, wherein the monitoring data comprises one or more of a publisher data flow rate, a data processing flow rate, a computing resource consumption amount, and a data storage rate.

4. The computer-implemented method of claim 3, wherein the data publisher is configured to transmit publisher data to the data processing unit at the publisher data flow rate, wherein the data processing unit is configured to generate data processing data based at least in part on the publisher data, wherein the data processing unit is configured to transmit the data processing data to the database at the data processing flow rate.

5. The computer-implemented method of claim 4, wherein causing the first controller to control the data publisher comprises causing the first controller to instruct the data publisher to increase the publisher data flow rate or decrease the publisher data flow rate.

6. The computer-implemented method of claim 5, wherein decreasing the publisher data flow rate comprises the data publisher storing at least a portion of the publisher data in a data publisher cache.

7. The computer-implemented method of claim 4, wherein causing the first controller to control the data processing unit comprises causing the first controller to instruct the data processing unit to increase the computing resource consumption amount or decrease the computing resource consumption amount.

8. The computer-implemented method of claim 4, wherein causing the second controller to control the data processing unit comprises causing the second controller to instruct the data processing unit to increase the data processing flow rate or decrease the data processing flow rate.

9. The computer-implemented method of claim 8, wherein decreasing the data processing flow rate comprises the data processing unit storing at least a portion of the data processing data in a data processing unit cache.

10. The computer-implemented method of claim 4, wherein causing the second controller to control the database comprises causing the second controller to instruct the database to increase the data storage rate or decrease the data storage rate.

11. An apparatus comprising at least one processor and at least one non-transitory memory including computer-coded instructions thereon, the computer coded instructions, with the at least one processor, cause the apparatus to:
receive monitoring data representing operations of a data publisher, a data processing unit, and a database;
determine a first data processing error associated with the data publisher and the data processing unit based at least in part on the monitoring data;
determine a second data processing error associated with the data processing unit and the database based at least in part on the monitoring data;
cause a first controller to control the data publisher or the data processing unit based at least in part on the first data processing error; and
cause a second controller to control the data processing unit or the database based at least in part on the second data processing error.

12. The apparatus of claim 11, the monitoring data comprises one or more of a publisher data flow rate, a data processing flow rate, a computing resource consumption amount, and a data storage rate.

13. The apparatus of claim 12, wherein the data publisher is configured to transmit publisher data to the data processing unit at the publisher data flow rate, wherein the data processing unit is configured to generate data processing data based at least in part on the publisher data, wherein the data processing unit is configured to transmit the data processing data to the database at the data processing flow rate.

14. The apparatus of claim 13, wherein causing the first controller to control the data publisher comprises causing the first controller to instruct the data publisher to increase the publisher data flow rate or decrease the publisher data flow rate.

15. The apparatus of claim 14, wherein decreasing the publisher data flow rate comprises the data publisher storing at least a portion of the publisher data in a data publisher cache.

16. The apparatus of claim 13, wherein causing the first controller to control the data processing unit comprises causing the first controller to instruct the data processing unit to increase the computing resource consumption amount or decrease the computing resource consumption amount.

17. The apparatus of claim 13, wherein causing the second controller to control the data processing unit comprises causing the second controller to instruct the data processing unit to increase the data processing flow rate or decrease the data processing flow rate.

18. The apparatus of claim 17, wherein decreasing the data processing flow rate comprises the data processing unit storing at least a portion of the data processing data in a data processing unit cache.

19. The apparatus of claim 13, wherein causing the second controller to control the database comprises causing the second controller to instruct the database to increase the data storage rate or decrease the data storage rate.

20. A computer program product comprising at least one non-transitory computer-readable storage medium having computer program code stored thereon that, in execution with at least one processor, configures the computer program product for:
receiving monitoring data representing operations of a data publisher, a data processing unit, and a database;
determining a first data processing error associated with the data publisher and the data processing unit based at least in part on the monitoring data;
determining a second data processing error associated with the data processing unit and the database based at least in part on the monitoring data;
causing a first controller to control the data publisher or the data processing unit based at least in part on the first data processing error; and
causing a second controller to control the data processing unit or the database based at least in part on the second data processing error.
